(19) United States
(12) Patent Application Publication
(10) Pub. No.: US 2003/0194171 A1
(43) Pub. Date: Oct. 16, 2003

(54) Mechanical optical switching device

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/172,156

(22) Filed: Jun. 13, 2002

(30) Foreign Application Priority Data
Apr. 12, 2002 (TW) 91204880

(51) Int. Cl. G02B 6/35; G02B 6/32

(52) U.S. Cl. 385/17; 385/16; 385/20; 385/33

(57) ABSTRACT

A mechanical optical switching device includes an input assembly (21), an output assembly (22), an optical switching assembly (23), and a driving means (27). The input assembly includes a plurality of input optical fibers (211) and a multi-fiber ferrule (212). The output assembly includes a plurality of output optical fibers (221) and a multi-fiber ferrule (222). The optical switching assembly is positioned between the input and output assemblies, and includes two arrays of lenses (231, 232). Each lens has a slanted end face (50), and an opposite aspherically curved end face (70). Two holding boards (251, 252) fixedly retain the lenses of the two arrays of lenses therein. The driving means can drivingly move the holding boards. Accordingly, various of the lenses of the two arrays of lenses can be moved to align with the input assembly and the output assembly, thereby providing switching of optical transmission paths between the input and output optical fibers.

### BACKGROUND OF THE INVENTION

1. Field of the Invention

This invention relates to an optical switching device for optical communication and, more particularly to a mechanical optical switching device having movable lenses for switching optical transmission paths.

2. Description of the Prior Art

Optical communication systems using optical fibers as a transmission medium have been rapidly developed in recent times and attracted much public attention. Optical switching devices are indispensable for mutual connection and disconnection of optical transmission paths.

Optical switching devices are categorized into mechanical optical switching devices and non-mechanical switching devices. A mechanical optical switching device uses a motor or an electromagnet to shift an optical fiber or an optical element, so as to attain switching of optical transmission paths between different output assemblies. This kind of optical switching device is popular due to its low insertion loss and high isolation.

FIG. 6, shows a shifted optical fiber type switch as disclosed in U.S. Pat. No. 4,146,856. The disclosure thereof is incorporated herein by reference. This optical switching device comprises an envelope 10, a pair of magnetically permeable reed arms 111, 112, three support members 121, 122, 123, and three optical fibers 131, 132, 133. The reed arms 111, 112 are mounted to opposite ends (not labeled) of the envelope 10. Th e reed arms 111, 112 respectively extend into the envelope 10 and overlap each other at inner ends (not shown) thereof. The support member 121 defines a bore 124, and is attached to a top of the end of the reed arm 112. The support member 122 defines a bore 125, and is attached to an inner wall of the envelope 10. The support member 123 defines a bore 126, and is mounted to the end of the reed arm 111 such that it generally opposes the support member 121. Three optical fibers 131, 132, 133 extend through the ends of the envelope 10, and are respectively secured in the bores 124, 125, 126 of the support members 121, 122, 123. When the reed arms 111, 112 are magnetized such that they have opposite polarities, they abut against each other. The optical fiber 131 is thus aligned with optical fiber 133. When the reed arms 111, 112 are magnetized such that they have the same polarity, they repel each other such that the support member 121 abuts against the inner wall. The optical fiber 131 is thus aligned with the optical fiber 132. In this way, optical transmission paths can be switched. However, a misalignment can often occur when the position of the moveable optical fiber 131 changes too frequently. Misalignment increases optical loss and reduces the quality of the transmitted light.

FIG. 7 shows a shifted optical element type switch as disclosed in U.S. Pat. No. 5,420,946. The disclosure thereof is incorporated herein by reference. This optical switching device comprises an input assembly 14, a reflector assembly 15, and a plurality of output assemblies 16. The input assembly 14 comprises an input optical fiber 141, and a graded refractive index (GRIN) lens 142 for collimating light beams emanating from the input optical fiber 141 and transmitting to the reflector assembly 15. The reflector assembly 15 comprises a base 151, a reflector 152 formed on the base 151, and a hole 153 defined in an underside of the base 151. The reflector 152 forms a forty-five degree angle with respect to the light beams collimated by the GRIN lens 142. A central axis of the hole 153 and a central axis of the GRIN lens 142 are in alignment with each other, thereby forming a common axis. The hole 153 engagingly receives a shaft (not shown) of a motor, for driving the reflector assembly 15 to rotate about the common axis. Each output assembly 16 comprises an output optical fiber 161, and a GRIN lens 162 for focusing light beams emanating from the reflector assembly 15 to the output optical fiber 161. The output assemblies 16 are arranged in a circle around the reflector assembly 15. Central axes respectively of the GRIN lenses 162 all coincide with each other at a point on the reflector 152, the point being located on the common axis. Thus incident light beams from the input optical fiber 141 can be coupled into a desired output assembly 16 by rotating the reflector assembly 15. Thus, optical transmission paths can be switched.

However, the structure of this optical switching device is problematic. Each output assembly 16 must be accurately arranged around the reflector assembly 15. Rotation of the reflector assembly 15 must be accurately controlled. In addition, the multiplicity of output assemblies 16 required necessitates having a multiplicity of GRIN lenses 162. This unduly inflates costs, and limits the scope for miniaturization of the optical switching device. The copending application with an unknown serial number filed on Jun. 10, 2002, titled “OPTICAL SWITCH” with the same applicant and the same assignee as the invention, disclose one approach.

### SUMMARY OF THE INVENTION

Accordingly, an object of the present invention is to provide a mechanical optical switching device that is cheap and easy to assemble.

To achieve the above objects, a mechanical optical switching device in accordance with the present invention comprises an input assembly, an output assembly, an optical switching assembly, a lens holder and a driving means. The input assembly comprises a plurality of input optical fibers, and a multi-fiber ferrule holding the input optical fibers therein. The output assembly comprises a plurality of output optical fibers, and a multi-fiber ferrule holding the output optical fibers therein. The optical switching assembly is positioned between the input and output assemblies, and comprises two arrays of lenses. Each lens has a slanted end face, and an opposite aspherically curved end face. Two holding boards respectively fixedly retain the lenses of the two arrays of lenses therein. The driving means can drivingly move the holding boards. Accordingly, various of the lenses of the two arrays of lenses can be moved to align with the input and output assemblies, thereby providing switching of optical transmission paths between the input and output optical fibers.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is a schematic isometric view of a mechanical optical switching device of the present invention;

FIG. 2 is a top plan cross-sectional view of the mechanical optical switching device taken along line 2-2 of FIG. 1;

FIG. 3 is a side plan cross-sectional view of the mechanical optical switching device taken along line 3-3 of FIG. 1;

FIG. 4A is a schematic cross-sectional view of a multi-fiber holding portion of the mechanical optical switching device taken along line 4A-4A of FIG. 2;

FIG. 4B is a schematic end view of a multi-fiber ferrule of the mechanical optical switching device taken along line 4B-4B of FIG. 2;

FIG. 5A is a schematic cross-sectional view showing optical transmission paths obtained by employing two lenses of the mechanical optical switching device of FIG. 1;

FIG. 5B is similar to FIG. 5A, but showing different optical transmission paths obtained by substituting one of the lenses of FIG. 5A with another lens;

FIG. 6 is a partially cut-away side plan view of a conventional optical switching device; and

FIG. 7 is a perspective view of another conventional optical switching device.

### DETAILED DESCRIPTION OF THE PREFERRED EMBODIMENT

The present invention is further described below and by reference to the figures, in which the same numbers are used to indicate the same elements.

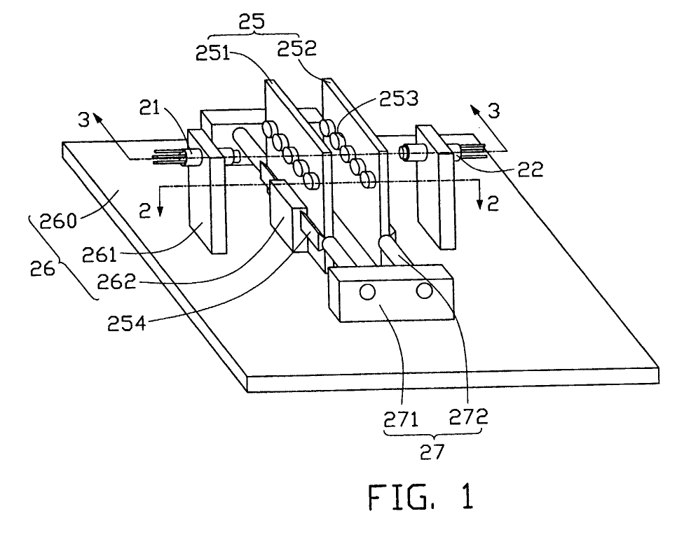

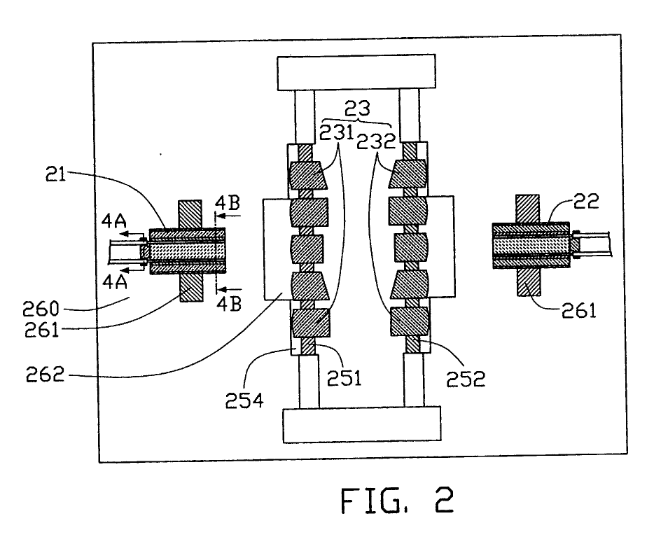

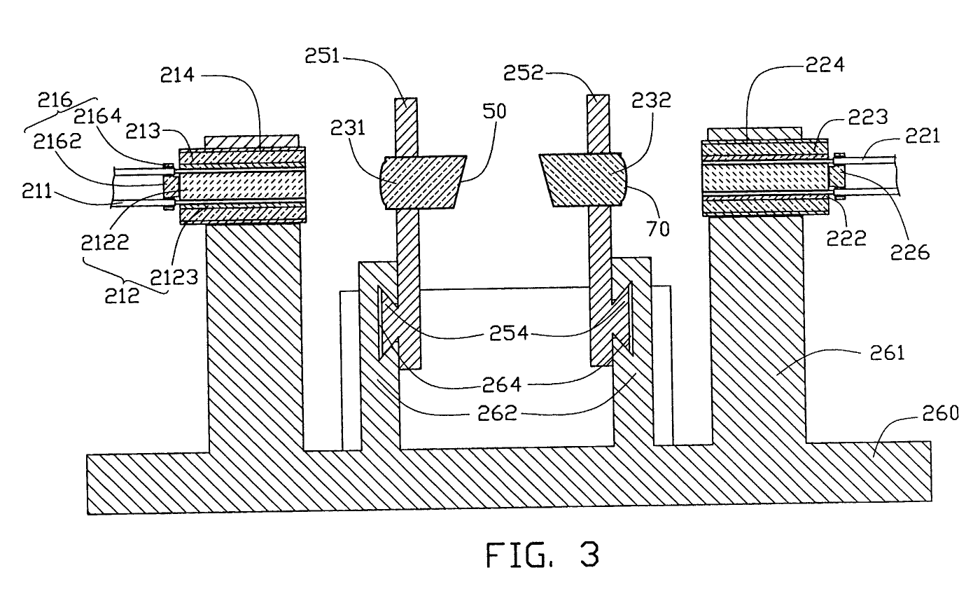

Referring to the FIGS. 1 to 3, a mechanical optical switching device in accordance with the present invention comprises an input assembly 21, an output assembly 22, an optical switching assembly 23, a lens holder 25, a support assembly 26, and a driving means 27. The optical switching assembly 23 includes an array of first lenses 231, and an array of second lenses 232. The lens holder 25 retains the two arrays of lenses 231, 232.

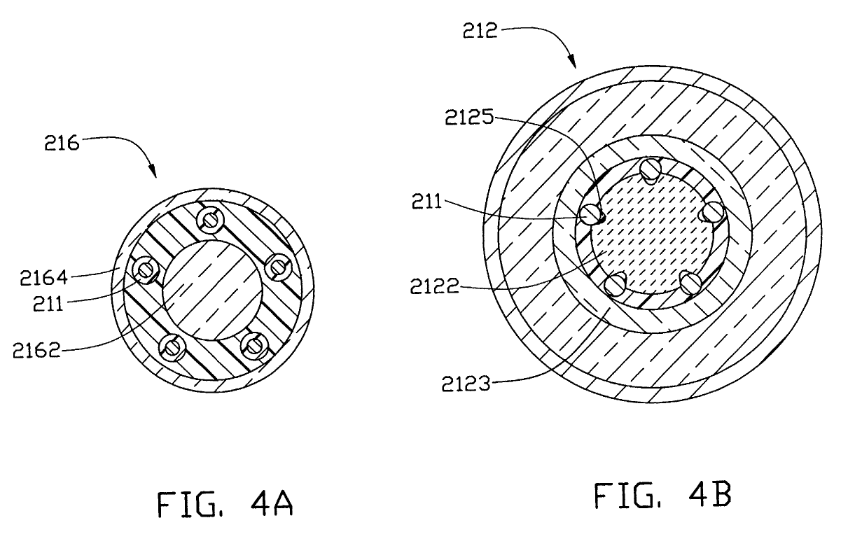

The input assembly 21 comprises a plurality of input optical fibers 211 for transmitting light beams into the mechanical optical switching device, a holding portion 216, a multi-fiber ferrule 212, an inner tube 213, and an outer casing 214. The holding portion 216 holds sheathed portions of the input optical fibers 211 therein, and abuts an outer end of the multi-fiber ferrule 212. The multi-fiber ferrule 212 holds unsheathed portions of the input optical fibers 211 therein. Referring also to FIG. 4A, the holding portion 216 comprises an inner core 2162 and an outer ring 2164. The sheathed portions of the optical fibers 211 are evenly distributed and firmly secured between the inner core 2162 and the outer ring 2164. In the preferred embodiment, the sheathed portions of the optical fibers 211 are further secured with epoxy (shown as the hatched areas in FIG. 4A, not labeled). Referring also to FIG. 4B, the multi-fiber ferrule 212 comprises an inner core 2122, and an outer cladding 2123. The unsheathed portions of the optical fibers 211 are evenly distributed and firmly secured between the inner core 2122 and the outer cladding 2123. In the preferred embodiment, a plurality of parallel and evenly spaced grooves 2125 is longitudinally defined in a circumferential surface of the inner core 2122. Each groove 2125 has a V-shaped profile, in order to achieve optimum fixing and accurate positioning of the unsheathed portions of the input optical fibers 211. The unsheathed portions of the optical fibers 211 are further secured in the grooves 2125 with epoxy (shown as the hatched areas in FIG. 4B, not labeled). The inner tube 213 surrounds the multi-fiber ferrule 212, which is firmly fixed therein. The outer casing 214 surrounds the inner tube 213, which is firmly fixed therein. The outer casing 214 generally retains and protects the input assembly 21.

The output assembly 22 comprises a plurality of output optical fibers 221, a holding portion 226, a multi-fiber ferrule 222 holding the output optical fibers 221 therein, an inner tube 223, and an outer sheath 224. The structure of the output assembly 22 is similar to the structure of the input assembly 21. Accordingly, for brevity, further detailed description of the output assembly 22 is omitted herefrom.

The optical switching assembly 23 is positioned between the input and output assemblies 21, 22. Each array of the first and second lenses 231, 232 is a linear array, with the two arrays of lenses 231, 232 generally opposing each other. Each lens 231, 232 which may be formed by molding lenses in place of conventional GRIN lenses comprises a slanted end face 50 forming a predetermined oblique angle relative to a central longitudinal axis of the lens 231, 232, for changing a direction of a light beam passing therethrough. Each lens 231, 232 further comprises an aspherically curved end face 70 opposite from the slanted end face 50. The aspherically curved end face 70 of each first lens 231 is for collimating input light beams from the input optical fibers 211. The aspherically curved end face 70 of each second lens 232 is for focusing output light beams to the output optical fibers 221. The two arrays of lenses 231, 232 are movable relative to each other, as explained in detail below. This enables switching of optical transmission paths between the input assembly 21 and the output assembly 22. Light beams emitted from any one of the input optical fibers 211 can be switched into a desired output optical fiber 221.

The lens holder 25 comprises a first holding board 251 and a second holding board 252. The first and second holding boards 251, 252 are oriented parallel to each other. A plurality of horizontally aligned mounting holes 253 is defined in a top portion of each of the first and second holding boards 251, 252, and the lenses 231, 232 are respectively fixedly mounted in the mounting holes 253. A horizontal slide rail 254 is formed on a lower portion of an outer face of each of the first and second holding boards 251, 252. Each slide rail 254 has a trapezoid cross-section. A shorter side (not shown) of the two parallel sides of the trapezoid cross-section coincides with the outer face of the respective first or second holding board 251, 252.

The support assembly 26 comprises a base 260, two first pedestals 261, and two second pedestals 262. The first pedestals 261 are mounted on opposite sides of the base 260, and parallel to each other. An aperture (not shown) is defined in a top portion of each first pedestal 261, fixedly receiving the respective input assembly 21 or output assembly 22. The input and output assemblies 21, 22 are aligned with each other along a common optical axis (not shown) defined the longitudinal central line of the multi-fiber ferrules 212, 222. The second pedestals 262 are mounted on the base 260 between the first pedestals 261, parallel to each other and parallel to the first pedestals 261. A horizontal guiding slot 264 is defined in an upper portion of an inner face of each second pedestal 262. Each guiding slot 264 has a trapezoid cross-section, similar to and complementary to the cross-section of the slide rail 254 of a corresponding respective first or second holding board 251, 252. Thus the first and second holding boards 251, 252 are slidably engaged with the second pedestals 262, and are parallel to the first pedestals 261.

The driving means 27 comprises two driving apparatuses 271 and four shafts 272. The driving apparatuses 271 are mounted on the base 260 near respective opposite ends of the lens holder 25. Two of the shafts 272 connect one of the driving apparatuses 271 with the first holding board 251 and the second holding board 252 respectively. The other two of the shafts 272 connect the other driving apparatus 271 with the first holding board 251 and the second holding board 252 respectively. The shafts 272 can thus drivingly move the first and second holding boards 251, 252 to slide along the second pedestals 262. Accordingly, various combinations of the first and second lenses 231, 232 can be moved to align with the common optical axis of the multi-fiber ferrules 212, 222, thereby providing switching of optical transmission paths between the input optical fibers 211 and the output optical fibers 221.

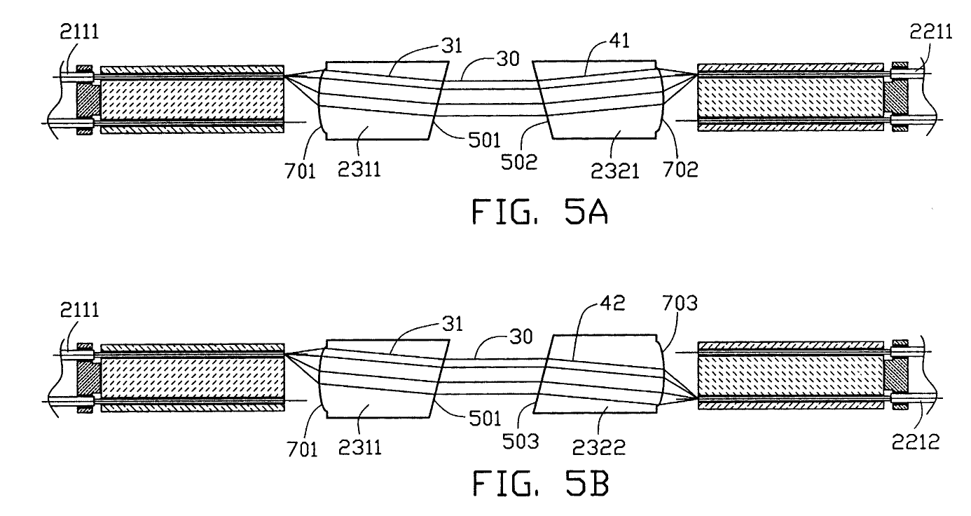

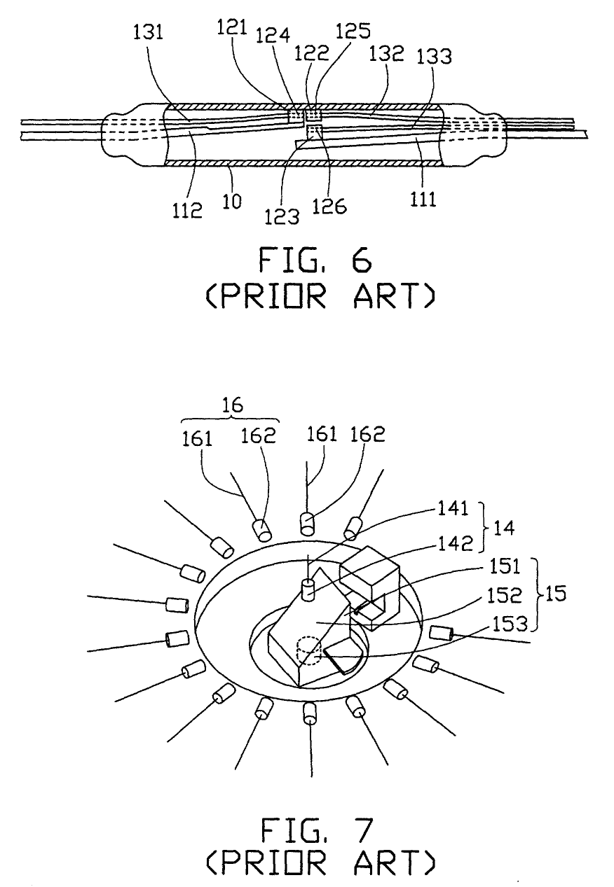

Referring to FIG. 5A, in operation, light beams emitted from one input optical fiber 2111 of the input optical fibers 211 pass through an aspherically curved end face 701 of one lens 2311 of the array of first lenses 231. The light beams are refracted by the aspherically curved end face 701 to become parallel light beams 31 in the lens 2311. The parallel light beams 31 form a tiny angle with respect to the longitudinal optical axis of the lens 2311, since a longitudinal axis of output end of the optical fiber 2111 is spaced from the longitudinal optical axis of the lens 2311. The parallel light beams 31 are refracted by a slanted end face 501 to become parallel light beams 30. The oblique angle of the slanted end face 501 is such that the parallel light beams 30 are also parallel to the longitudinal optical axis of the lens 2311. The parallel light beams 30 are refracted by a slanted end face 502 of a lens 2321 of the array of second lenses 232 to become parallel light beams 41 in the lens 2321. The parallel light beams 41 form a specified tiny angle with respect to a longitudinal optical axis of the lens 2321, according to the oblique angle of the slanted end face 502. The parallel light beams 41 are refracted by an aspherically curved end face 702 of the lens 2321 to be focused into an output optical fiber 2211 of the output optical fibers 221. Referring to FIG. 5B, another lens 2322 of the array of second lenses 232 is driven by the driving means 27 into the optical transmission path described above. Accordingly, the parallel light beams 30 are refracted by a slanted end face 503 of the lens 2322 to become parallel light beams 42 in the lens 2322. The parallel light beams 42 form a specified tiny angle with respect to a longitudinal optical axis of the lens 2322, according to the oblique angle of the slanted end face 503. The parallel light beams 42 are refracted by an asphericall curved end face 703 of the lens 2322 to be focused into an output optical fiber 2212 of the output optical fibers 221.

It is to be understood that light beams emitted from any one single input optical fiber 211 of the input assembly 21 can be transmitted into any selected one single output optical fiber 221 of the output assembly 22, by using the driving means 27 to drive an appropriate second lens 232 into the common optical axis of the multi-fiber ferrules 212, 222. Similarly, any selected first lens 231 of the array of first lenses 231 can be driven into the common optical axis of the multi-fiber ferrules 212, 222 by the driving means 27. Therefore, the mechanical optical switching device can transmit light beams emitted from any one single input optical fiber 211 of the input assembly 21 into desired any one single output optical fiber 221 of the output assembly 22. Moreover, the optical transmission paths are reversible; therefore light beams can be selectively transmitted in a reverse direction in similar fashion to that described above.

As described above, the mechanical optical switching device of the present invention provides a pair of multi-fiber ferrules 212, 222 each holding a plurality of associated optical fibers 211, 221, and the optical transmission paths are switchable by the driving of the two arrays of lenses 231, 232. Thus the mechanical optical switching device is cheaper because of no necessary GRIN lenses, more environmentally friendly because of no chemicals to make GRIN lenses and easier to assemble because new ferrule design is easier to align than the conventional optical switching device.

It will be understood that the particular device embodying the present invention is shown and described by way of illustration only, and not as limiting the invention. The principles and features of the present invention may be employed in various and numerous embodiments thereof without departing from the scope of the invention.

What is claimed is:

1. A mechanical optical switching device, comprising:
an input assembly comprising a plurality of input optical fibers and a multi-fiber ferrule holding said input optical fibers therein;
an output assembly comprising a plurality of output optical fibers and a multi-fiber ferrule holding said output optical fibers therein;
two lens arrays disposed between said input assembly and said output assembly, each of said lens arrays comprising a plurality of lenses; and
a driving means for driving said lenses of said lens arrays in order to switch optical transmission paths between said input assembly and said output assembly;
wherein said multi-fiber ferrules of said input assembly and said output assembly each comprise an inner core and an outer cladding, and said input optical fibers and output optical fibers are respectively evenly spaced and fixedly secured between said inner core and outer cladding.

2. The switching device of claim 1, wherein said input assembly further comprises an inner tube and an outer casing, said inner tube surrounds and fixes said multi-fiber ferrule therein, and said outer casing surrounds and fixes said inner tube therein whereby said outer casing retains and protects said input assembly.

3. The switching device of claim 1, wherein said output assembly further comprises an inner tube and an outer casing, said inner tube surrounds and fixes said multi-fiber ferrule therein, and said outer casing surrounds and fixes said inner tube therein whereby said outer casing retains and protects said output assembly.

4. The switching device of claim 1, further comprising a lens holder for fixing the lenses, wherein said lens holder comprises two boards, a plurality of holes is defined in each of said boards, and said lenses of each lens array are respectively fixedly mounted in said holes of a respective board, one lens array to one board.

5. The switching device of claim 4, wherein each of said lenses of said lens arrays comprises an aspherically curved end face for collimating or focusing respective input or output light beams.

6. The switching device of claim 5, wherein said each of said lenses of said lens arrays further comprises a slanted end face forming a predetermined oblique angle with a longitudinal axis of said lens for changing a direction of light beams passing therethrough.

7. The switching device of claim 6, further comprising a support assembly, said support assembly comprising a base, two first pedestals and two second pedestals.

8. The switching device of claim 7, wherein said first pedestals are parallel to each other, and an aperture is defined in each of said first pedestals fixedly receiving respective said input assembly or output assembly.

9. The switching device of claim 8, wherein said second pedestals are parallel to said first pedestals and positioned therebetween.

10. The switching device of claim 9, wherein each of said second pedestals defines a guiding slot.

11. The switching device of claim 10, wherein each of said boards comprises a slide rail slidably engaged in a corresponding one of said guiding slots.

12. The switching device of claim 11, wherein said driving means comprises two driving apparatuses and four shafts, and said shafts connect said driving apparatuses with said boards respectively for driving said lenses of said lens arrays to switch optical transmission paths.

13. A mechanical optical switching device, comprising:
an input assembly comprising a plurality of input optical fibers and a multi-fiber ferrule holding said input optical fibers therein;
an output assembly comprising a plurality of output optical fibers and a multi-fiber ferrule holding said output optical fibers therein;
two lens arrays disposed between said input assembly and said output assembly, each of said lens arrays comprising a plurality of lenses, each of said lenses comprising an aspherically curved end face for collimating or focusing respective input or output light beams;
a lens holder comprising two boards, each of said boards comprising a plurality of holes fixedly receiving said lenses of a respective one of said lens arrays; and
a driving means for driving said lenses of said lens arrays in order to switch optical transmission paths;
wherein said multi-fiber ferrules of said input assembly and said output assembly each comprise an inner core and an outer cladding, and said input optical fibers and output optical fibers are respectively evenly spaced and fixedly secured between said inner core and outer cladding.

14. The switching device of claim 13, further comprising a support assembly, said support assembly comprising a base, two first pedestals and two second pedestals, wherein said first pedestals are parallel to each other, an aperture is defined in each of said first pedestals fixedly receiving respective said input assembly or output assembly, said second pedestals are parallel to said first pedestals and positioned therebetween, each of said second pedestals defines a guiding slot, and each of said boards comprises a slide rail slidably engaged in a corresponding one of said guiding slots.

15. A mechanical optical switch comprising:
an input assembly including a plurality of input fibers enclosing in a first holder;
an output assembly including a plurality of output fibers enclosing in a second holder; and
two light deflection devices moveable between said input assembly and said output assembly to result in different selective light paths each passing one selected input fiber and one selected output fiber; wherein
at least one of said first and second holder comprises an inner core and an coaxial outer cladding with the corresponding fibers sandwiched therebetween.

16. The switch of claim 15, wherein said corresponding fibers between said inner core and said outer cladding are essentially evenly spaced along a circumference.
